(19) United States
(12) Patent Application Publication
(10) Pub. No.: US 2024/0323479 A1
(43) Pub. Date: Sep. 26, 2024

(54) MEDIA DISPLAY METHOD, MEDIA DISPLAY APPARATUS, AND STORAGE MEDIUM

(71) Applicant: Beijing Youzhuju Network Technology Co., Ltd., Beijing (CN)

(72) Inventors: Hao WU, Beijing (CN); Qinyuan ZHANG, Beijing (CN); Liangcheng XU, Beijing (CN)

(21) Appl. No.: 18/573,383

(22) PCT Filed: Aug. 30, 2022
(86) PCT No.: PCT/CN2022/115830

§ 371 Date: Dec. 21, 2023

(30) Foreign Application Priority Data
Oct. 11, 2021 (CN) 202111182857.6

(51) Int. Cl. H04N 21/431; H04N 21/482

(52) U.S. Cl. CPC H04N 21/4316; H04N 21/4826

(57) ABSTRACT

The present disclosure relates to a media display method, a media display apparatus, and a storage medium. The media display method includes providing a media display page, which includes a media source display region; obtaining respective identification information of currently available media sources and displaying the identification information of the currently available media sources in the media source display region; and in response to a first operation instruction for the media display page, changing a display manner of the media source display region.

### CROSS-REFERENCE TO RELATED APPLICATION

This application claims the priority of Chinese Patent Application No. 202111182857.6 filed on Oct. 11, 2021, the disclosure of which is incorporated by reference herein in its entirety as part of the present application.

### TECHNICAL FIELD

Embodiments of the present disclosure relate to a media display method, a media display apparatus, and a storage medium.

### BACKGROUND

Live streaming is a format emerging with the development of technologies such as mobile Internet and is a network content service form that allows network hosts to synchronously provide live streaming tools on a live streaming platform by means of live streaming tools such as Internet and a mobile phone or a computer without voice or video recording.

In terms of live streaming type, live streaming may be roughly divided into live streaming of a show, live streaming of a game, vertical field live streaming (e-commerce live streaming, live streaming of sports, etc.), live streaming of pan-entertainment, and the like. In recent years, e-commerce live streaming has been developing rapidly in China. Most of the time, people are at home, and e-commerce live streaming becomes a choice for a large number of live streaming users.

### SUMMARY

At least one embodiment of the present disclosure provides a media display method, comprising: providing a media display page, wherein the media display page comprises a media source display region; obtaining respective identification information of currently available media sources and displaying the identification information of the currently available media sources in the media source display region; and in response to a first operation instruction for the media display page, changing a display manner of the media source display region.

For example, in the media display method provided by at least one embodiment of the present disclosure, the changing the display manner of the media source display region comprises: changing a display manner of the identification information of the currently available media sources.

For example, in the media display method provided by at least one embodiment of the present disclosure, the display manner comprises at least one of a display position, a display size, and a display form.

For example, in the media display method provided by at least one embodiment of the present disclosure, the displaying the identification information of the currently available media sources in the media source display region comprises: displaying identification information of a first number of currently available media sources of the currently available media sources in parallel in the media source display region; and the changing the display manner of the identification information of the currently available media sources comprises: displaying identification information of a second number of currently available media sources of the currently available media sources, wherein the second number is less than the first number.

For example, in the media display method provided by at least one embodiment of the present disclosure, the displaying the identification information of the second number of currently available media sources of the currently available media sources comprises: alternately displaying the identification information of the currently available media sources with the second number of pieces of identification information as a set.

For example, in the media display method provided by at least one embodiment of the present disclosure, the second number is 1.

For example, the media display method provided by at least one embodiment of the present disclosure further comprises: in response to the first operation instruction for the media display page, displaying a total number of the currently available media sources in the media source display region of which the display manner has been changed.

For example, the media display method provided by at least one embodiment of the present disclosure further comprises: updating and displaying the total number of the currently available media sources according to an increase or a decrease of the currently available media sources.

For example, the media display method provided by at least one embodiment of the present disclosure further comprises: in response to a new media source becoming available and thereby becoming one of the currently available media sources, displaying identification information of the new media source in the media source display region of which the display manner has been changed.

For example, in the media display method provided by at least one embodiment of the present disclosure, the displaying identification information of the new media source in the media source display region of which the display manner has been changed comprises: displaying the identification information of the new media source in a different display manner from the identification information of the first number of media sources in the media source display region of which the display manner has been changed.

For example, in the media display method provided by at least one embodiment of the present disclosure, the first operation instruction is generated by an interactive event for the media display page.

For example, in the media display method provided by at least one embodiment of the present disclosure, the interactive event includes an interactive operation on the overlay of the media display page.

For example, in the media display method provided by at least one embodiment of the present disclosure, the currently available media source is a video live media source.

For example, in the media display method provided by at least one embodiment of the present disclosure, a media content is shown in the media display page, and the media content comprises pictures of a plurality of objects corresponding to the media content; the method further comprises: displaying the pictures of the plurality of objects involved in the currently available media sources during live streaming in such a manner that the pictures are stacked; and in response to a second operation instruction for the media display page, changing a picture of an object shown on the top of the stacked pictures.

For example, the media display method provided by at least one embodiment of the present disclosure further comprises: obtaining respective state information of subscribed one or more media sources, and determining the currently available media sources.

At least one embodiment of the present disclosure also provides a media display apparatus, comprising: a first display unit configured to provide a media display page, which comprises a media source display region; a second display unit configured to obtain respective identification information of currently available media sources and show the identification information of the currently available media sources in the media source display region; and a third display unit configured to, in response to a first operation instruction for the media display page, change a display manner of the media source display region.

At least one embodiment of the present disclosure also provides a media display apparatus, comprising: a processor; a memory; and one or more computer program modules, wherein the one or more computer program modules are stored on the memory and configured to be executed by the processor; and the one or more computer program modules comprise(s) instructions for execution to implement the media display method provided by any embodiment of the present disclosure.

At least one embodiment of the present disclosure also provides a storage medium, storing, in a non-transitory manner, computer-readable instructions which, when executed by a computer, cause performing the media display method provided by any embodiment of the present disclosure.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a flowchart of an example of a media display method provided in at least one embodiment of the present disclosure;

FIG. 2 is a schematic diagram of a media display page provided in at least one embodiment of the present disclosure;

FIG. 3A and FIG. 3B are schematic diagrams of a media display page in some examples provided in at least one embodiment of the present disclosure;

FIG. 4A to FIG. 4C are schematic diagrams of a media display page in some other examples provided in at least one embodiment of the present disclosure;

FIG. 5 is a schematic diagram of a media display system provided in at least one embodiment of the present disclosure;

FIG. 6 is a schematic block diagram of a media display apparatus provided in at least one embodiment of the present disclosure;

FIG. 7 is a schematic block diagram of another media display apparatus provided in at least one embodiment of the present disclosure;

FIG. 8 is a structural schematic diagram of an electronic device provided in at least one embodiment of the present disclosure; and

FIG. 9 is a schematic diagram of a storage medium provided in at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

At present, when a user views a live video of a live streaming platform, the user can only see the current host and cannot know whether there are other hosts are performing a live streaming. Besides, a currently displayed live streaming interface has only a single display effect and the interaction between the user and the live streaming interface is low. Therefore, it is hard to enhance the experience of the user.

At least one embodiment of the present disclosure provides a media display method, including: providing a media display page, where the media display page includes a media display region and a media source display region; obtaining respective identification information of currently available media sources and displaying the identification information of the currently available media sources in the media source display region, where the currently available media sources include a first media source; displaying a media content obtained from the first media source in the media display region; and in response to a first operation instruction for the media display page, changing a display manner of the media source display region.

Some embodiments of the present disclosure further provide a media display apparatus and a storage medium that correspond to the media display method described above.

The media display method allows for display currently available media sources in the media source display region so that a user can perceive a real-time change state of the currently available media sources, thereby increasing interactive operations between the user and the media display page and enhancing the user's use experience. In addition, the display region for the media content can be enlarged to show more media content information, thereby enhancing the user experience and increasing the volume of information of user activities. Meanwhile, the display of the media sources is changed by sliding up and down, allowing for dynamic carousel. The interactive ways are enriched and the diversified interaction demands are met better.

The embodiments of the present disclosure and examples thereof are described in detail below with reference to the accompanying drawings.

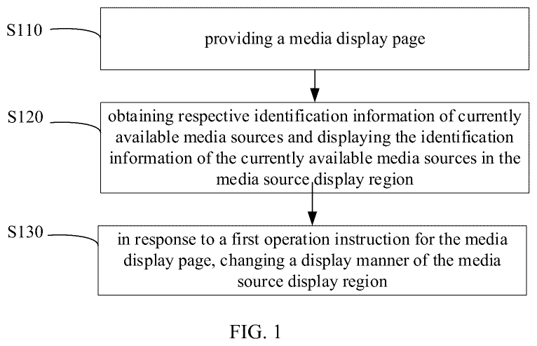

At least one embodiment of the present disclosure provides a media display method, which, for example, can be applied to live streaming platforms. For example, the media display method can be applied to a live streaming display interface of a subscription in an application by which the live streaming interface can be viewed, etc. However, the embodiments of the present disclosure have no limitation on this. FIG. 1 is a flowchart diagram of an example of a media display method provided in at least one embodiment of the present disclosure. For example, the media display method may be implemented by software, hardware, firmware, or any combination thereof, is loaded and performed by a processor in a device such as a mobile phone, a Pad, a laptop, a desktop computer, and a network server, and can allow for displaying currently available media sources in a media source display region so that a user can perceive a real-time change state of the currently available media sources, thereby improving the user experience.

For example, the media display method is suited to a computing device. The computing device is any terminal device with a computing function, such as a mobile phone, a laptop, a Pad, and a desktop computer, which is capable of loading and performing the media display method, which will not be limited in the embodiments of the present disclosure. For example, the computing device may include a processing unit in other form having data processing capability and/or instruction execution capability such as a central processing unit (CPU) or a graphics processing unit (GPU), a storage unit, and the like. An operating system, an application programming interface (e.g., Open Graphics Library (OpenGL), Metal), and the like are installed on the computing device to implement the media display method provided in the embodiments of the present disclosure by running a code or instructions. For example, the computing device may further include a display component. The display component is, for example, a liquid crystal display (LCD), an organic light emitting diode (OLED) display screen, a quantum dot light emitting diode (QLED) display screen, a projection component, a VR head-mounted display device (e.g., a VR helmet, VR glasses), which will not be limited in the embodiments of the present disclosure. The display component may be configured to, for example, implement displaying of a media display page.

For example, in some examples, as shown in FIG. 1, the media display method includes steps S110 to S130.

Step S110: providing a media display page, wherein the media display page comprises a media source display region.

Step S120: obtaining respective identification information of currently available media sources and displaying the identification information of the currently available media sources in the media source display region.

Step S130: in response to a first operation instruction for the media display page, changing a display manner of the media source display region.

For step S110, for example, in some examples, a user may enter an application by tapping to open the media display page. For example, the media display page includes a media display region and a media source display region.

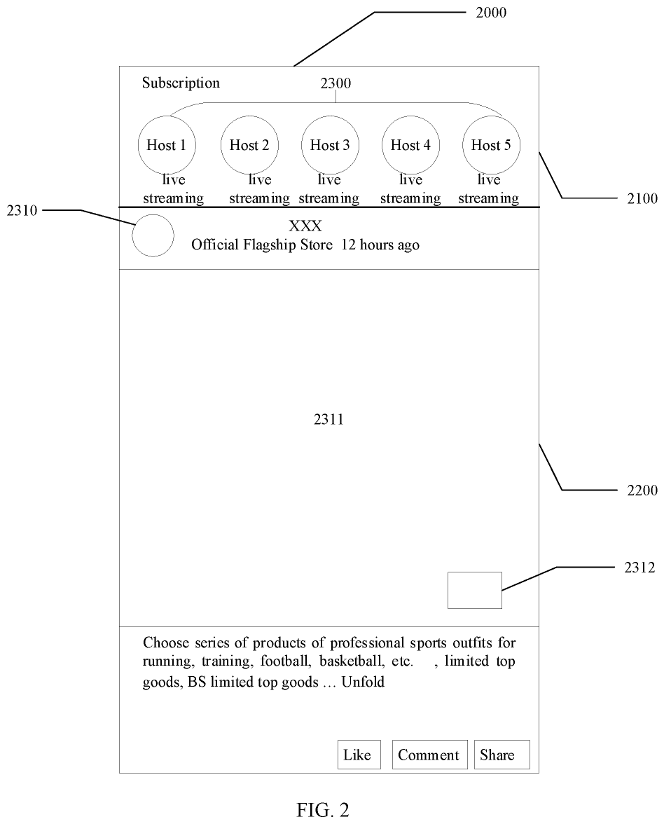

FIG. 2 is a schematic diagram of a media display page provided in at least one embodiment of the present disclosure. For example, in the example shown in FIG. 2, the media display page 2000 includes a media display region 2200 and a media source display region 2100. For example, the media display region 2200 is used to show a media content, and the media source display region 2100 is used to show identification information 2300 of currently available media sources of one or more media sources subscribed by a user.

For example, in some examples, a media source may be a subscription subscribed by the user, and the like. For example, the currently available media source may be a live video streaming media source, e.g., a subscription capable of live video streaming, which will not be limited in the embodiments of the present disclosure. For example, the currently available media source is a media source which is performing a live streaming currently. That is, the media source display region 2100 shows the identification information of the media source which is performing a live streaming online currently.

For example, in some examples, the subscription may be a video posting account, an official account, a life information posting account, etc., which will not be limited in the embodiments of the present disclosure. For example, the identification information may be an avatar identifier of a creator corresponding to the media content, e.g., an avatar of the subscription or other information capable of identifying the subscription.

For example, in some examples, the method further includes: obtaining respective state information of subscribed one or more media sources and determining the currently available media sources.

For example, the state information may include a live state, an online state, and the like of the media source, which may be specifically set according to actual situations, which will not be limited in the embodiments of the present disclosure. For example, in some examples, respective state information of the subscribed one or more media sources is obtained, and media sources which are performing a live streaming and which are online are determined as the currently available media sources.

For step S120, for example, step S120 includes: displaying the identification information of a first number of currently available media sources of the currently available media sources in parallel in the media source display region.

For example, as shown in FIG. 2, after determining the currently available media sources, the respective identification information of the currently available media sources is obtained, and the identification information of the first number of currently available media sources of the currently available media sources is shown in parallel in the media source display region 2100. For example, the currently available media sources are shown in parallel under the head title “subscription”.

For example, the first number is, for example, a number of all or part of the currently available media sources, which may be specifically determined according to a number that the media display page can display. For example, the size of the media display page is larger (wider), the greater the number of the currently available media sources shown.

It needs to be noted that the number of the currently available media sources may be greater than or equal to the first number. If the media display page can show all of the currently available media sources, a total number of the currently available media sources is equal to the first number; and if the media display page shows only part of the currently available media sources, the total number of the currently available media sources is greater than the first number, which will not be limited in the embodiments of the present disclosure.

For example, as shown in FIG. 2, five currently available media sources are shown in parallel in the media display region, and the remaining currently available media sources may be shown by a user sliding leftwards and rightwards, and may also be shown automatically, alternately, and circularly at predetermined time intervals, which will not be limited in the embodiments of the present disclosure.

For example, the currently available media sources 2300 include a first media source 2310. The first media source may be any selected one of the currently available media sources, e.g., any one shown in the media source display region 2100 or a media source not shown, which will not be limited in the embodiments of the present disclosure.

For step S130, for example, a media content of the selected one of the currently available media sources is shown in the media display region 2200.

For example, in some examples, media contents 2311 of all media sources subscribed from users are shown in the media display region 2200. For example, all the media sources include currently available media sources and currently unavailable media sources.

For example, in some examples, the media content shown in the media display region includes a live streaming process of a host, and may also include pictures 2312 of a plurality of objects corresponding to the media content. For example, the object may be a commodity picture which is performing a live streaming by a host, and may also be other picture related to the live streaming content, which will not be limited in the embodiments of the present disclosure.

For example, as shown in FIG. 2, the pictures 2312 of the plurality of objects are shown at the bottom right corner of the media display region to avoid covering the live streaming process of the host.

For example, in the example, the media display method further includes: displaying the pictures of the plurality of objects involved in the currently available media sources during live streaming in such a manner that the pictures are stacked; and in response to a second operation instruction for media display page, changing a picture of an object shown on the top of the stacked pictures.

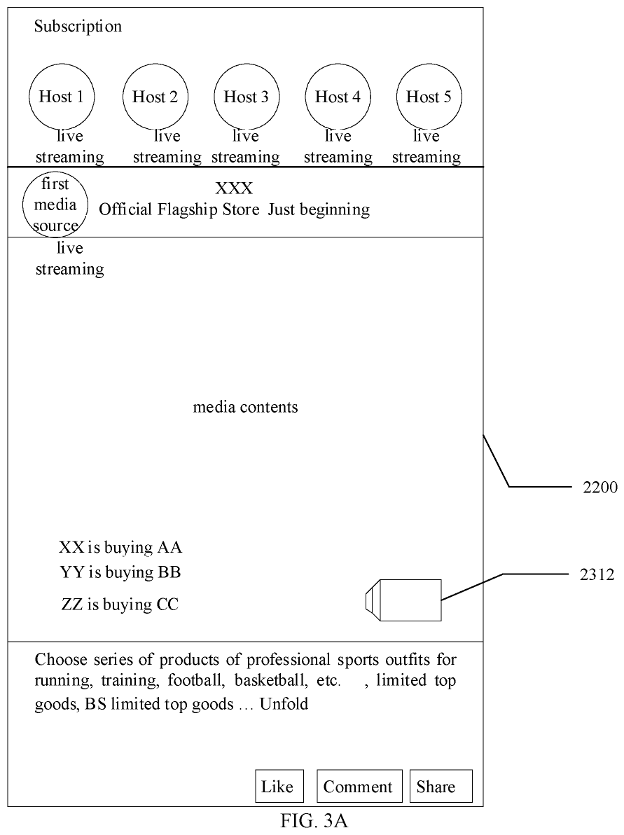

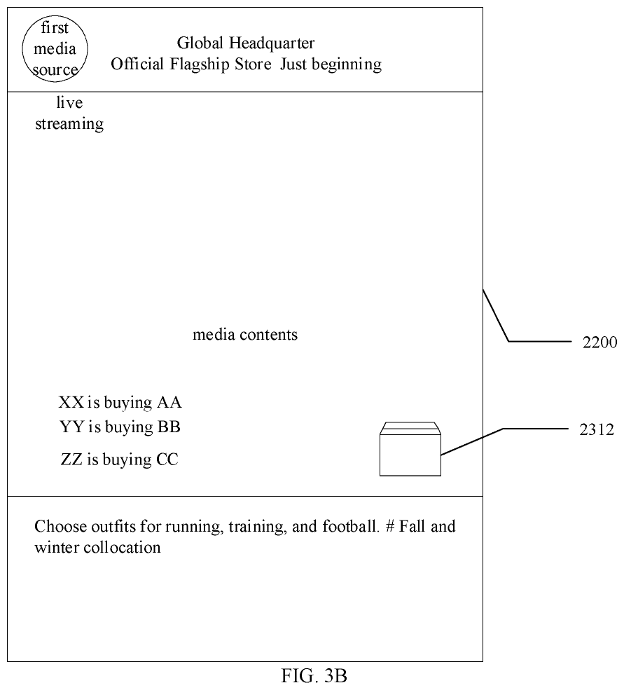

FIG. 3A and FIG. 3B are schematic diagrams of a media display page in some examples provided in at least one embodiment of the present disclosure. For example, the stacking manner may be displaying a stacking effect from left or right as shown in FIG. 3A, and may also be displaying a stacking effect from top or bottom as shown in FIG. 3B, which will not be limited in the embodiments of the present disclosure.

For example, as shown in FIG. 3A, the picture of the object includes an object which is preforming a live streaming, and may also include a price of the object, etc., which will not be limited in the embodiments of the present disclosure.

For example, as shown in FIG. 3A and FIG. 3B, the media display page shows the picture of the object which is being introduced. For example, when the object is a commodity, the picture of the commodity may be changed according to the commodity introduced in real time, and real-time buying behaviors of audiences are shown.

For example, when the commodity which is being introduced by the host changes, the host may replace the picture of the object shown on the top of the stacked pictures as the changed picture of the commodity by an interactive operation (e.g., tapping or dragging) with the media display page.

For step S130, for example, in response to the first operation instruction for the media display page 2000, the display manner of the media source display region 2100 is changed.

For example, a display manner of the identification information of the currently available media sources is changed, which includes: displaying the identification information of a second number of currently available media sources of the currently available media sources. For example, the second number is less than the first number.

For example, the first operation instruction is generated by an interaction event for the media display page 2000.

For example, the interaction event includes an interactive operation for an overlay of the media display page 2000. For example, a user can realize the interactive operation for the overlay of the media display page 2000 by sliding and dragging on a touch screen or by means of a mouse click (e.g., single click or double click).

For example, the user may view the media content 2321 obtained from other media source 2320 by sliding. When the media content of the media source 2320 overlays the identification information of the first number of currently available media sources of the currently available media sources shown in parallel in the media source display region 2100, the display manner of the media source display region 2100 is changed and the identification information of the second number of currently available media sources of the currently available media sources is shown.

For example, in some examples, changing the display manner of the media source display region includes: changing a position and a size of the media source display region, and/or changing the display manner of the identification information of the currently available media sources.

For example, the display manner includes at least one of a display position, a display size, and a display form. For example, the display form includes a display number, e.g., the first number being changed to the second number for display, which will not be limited in the embodiments of the present disclosure.

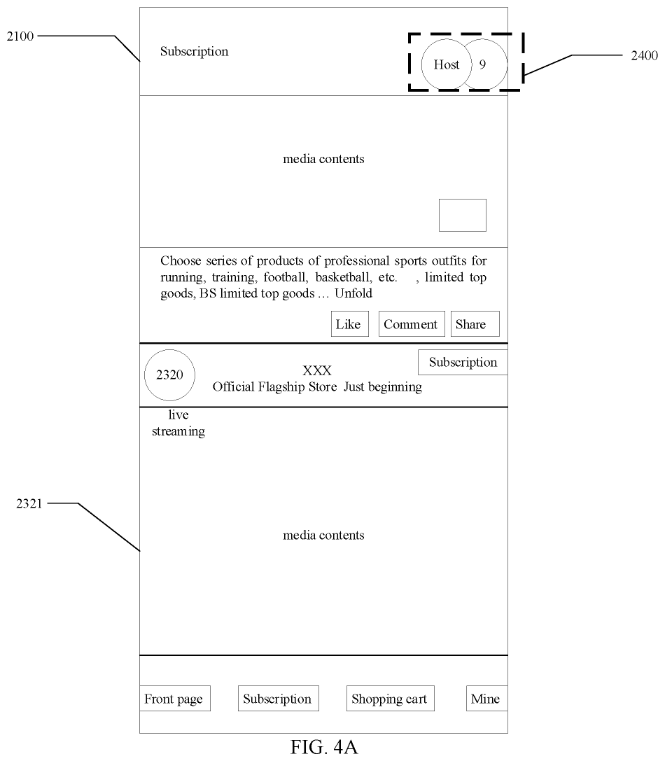

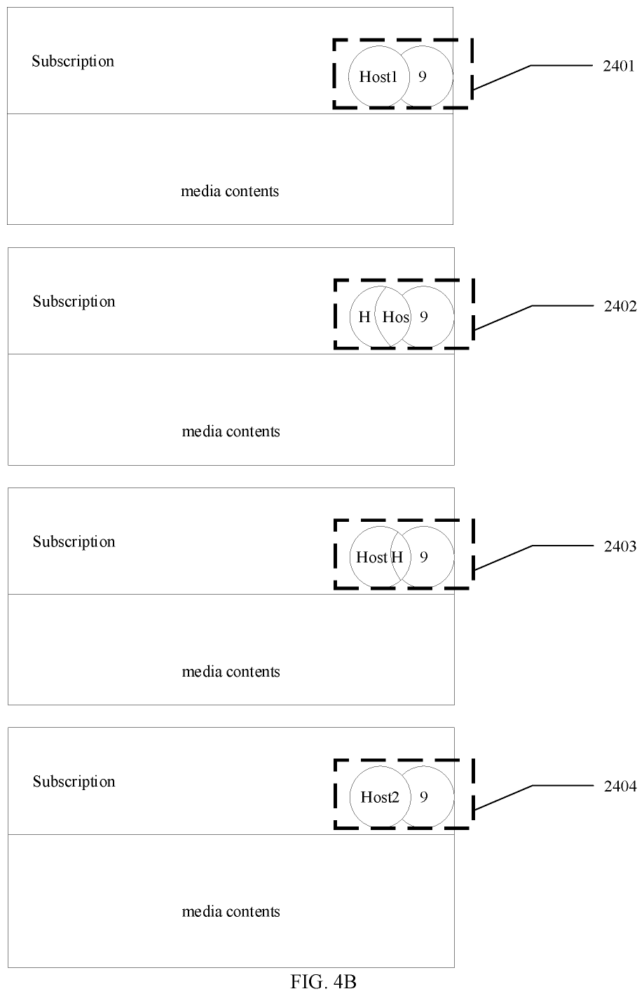

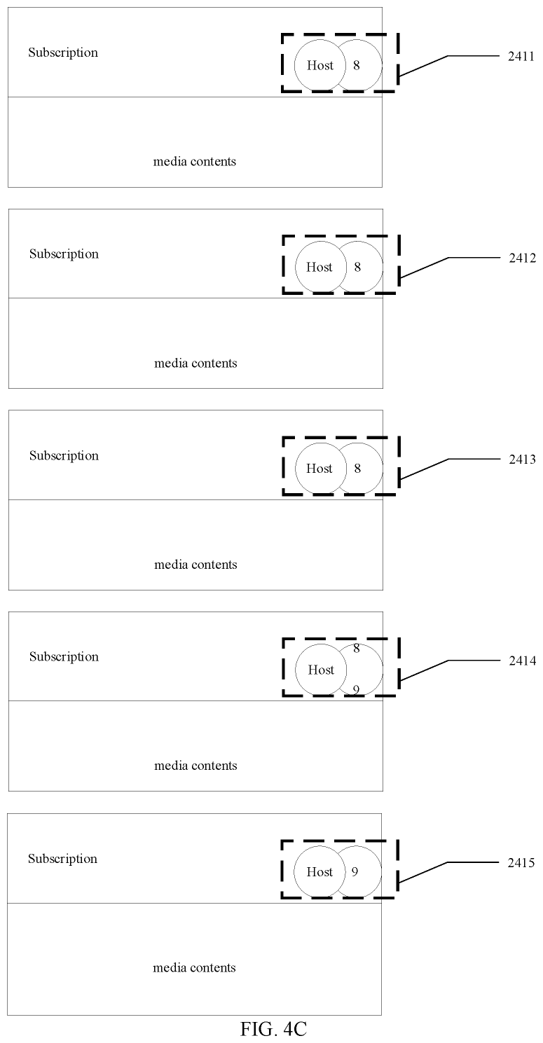

FIG. 4A to FIG. 4C are schematic diagrams of a media display page in some other examples provided in at least one embodiment of the present disclosure.

For example, the media source display region 2100 is changed from the position and the size shown in FIG. 2 to the position and size shown in FIG. 4A, e.g., from the position under the head title “subscription” shown in FIG. 2 to the position on the right of the head title “subscription”, and a size of the identification information of the media sources is reduced. For example, as shown in FIG. 4A, the size of the identification information of the media sources may be reduced according to a size of the head title. Other suitable positions and sizes may also be possible, which will not be limited in the embodiments of the present disclosure. For example, as shown in FIG. 4A, after sliding upwards, avatars of all hosts who are performing a live streaming will be reduced to the top right corner, and a number of current hosts is shown in number.

For example, in some examples, displaying the identification information of the second number of currently available media sources of the currently available media sources includes: alternately displaying the identification information of the currently available media sources with the second number of pieces of identification information as a set. For example, alternate displaying may be realized by responding to an operation instruction (e.g., an instruction of sliding rightwards) from a user, or at predetermined time intervals. For example, the identification information of the media sources is changed at intervals of, for example, 10 s or more or less time. Thus, the identification information of all the currently available media sources may be shown alternately so that the user can perceive which media sources are performing a live streaming or online, thereby enhancing the interactive experience of the user.

For example, in the examples shown in FIG. 4A to FIG. 4C, the second number is 1. For example, as shown in FIG. 4B, only the identification information of one media source is shown at the top right corner each time, and the identification information of all the currently available media sources can be played alternately by sliding rightwards. For example, when the identification information of the media sources is avatars of hosts, the avatars of the hosts who are performing a live streaming currently are played alternately by sliding rightwards. Thus, the hosts who are performing a live streaming currently can be viewed. As a matter of course, the identification information may also be played alternately and circularly by flipping or sliding downwards, leftwards, and upwards, and may also be directly changed to next identification information as long as changing of the identification information can be realized, which will not be limited in the embodiments of the present disclosure.

FIG. 4B illustrates a schematic diagram of an alternate displaying process of avatars of hosts. For example, as shown in FIG. 4B, 2401 represents the media source display region before the avatar of the host is changed; 2404 is the media source display region after the avatar of the host is changed; and 2401 and 2403 represent the media source display region in the process of changing the avatar of the host.

For example, in some other examples, the media display method further includes: in response to the first operation instruction for the media display page, displaying a total number of the currently available media sources in the media source display region of which the display manner has been changed.

For example, as shown in FIG. 4A and FIG. 4B, the total number of the currently available media sources is 9.

For example, in some examples, the media display method further includes: updating and displaying the total number of the currently available media sources according to an increase or a decrease of the currently available media sources.

For example, as shown in FIG. 4C, when the number of the currently available media sources changes from 8 to 9, the total number of the currently available media sources is changed to number “9” by flipping upwards. As a matter of course, the number may also be changed by flipping or sliding downwards, leftwards, and rightwards, and may also be directly changed to “9” as long as changing of the total number can be realized, which will not be limited in the embodiments of the present disclosure.

For example, the media source display region 2414 in FIG. 4C illustrates the process of changing the number from 8 to 9.

For example, the media display method further includes: in response to a new media source becoming available and thereby becoming one of the currently available media sources, displaying identification information of the new media source in the media source display region of which the display manner has been changed.

For example, display the identification information of the new media source in the media source display region of which the display manner has been changed includes: displaying the identification information of the new media source in a different display manner from the identification information of the first number of media sources (e.g., first media sources) in the media source display region of which the display manner has been changed.

For example, the new media source is, e.g., a host who just starts a live streaming. For example, a server detects that the host logs in and transmits the identification information of the avatar of the host to a terminal device, allowing the avatar of the host who just starts a live streaming to be shown in the media source display region 2400 (i.e., the reduced media source display region), i.e., allowing the identification information of the new media source to be shown.

For example, the different display manner from the identification information of the first media source may include a display manner of enlarging firstly and then reducing, a display manner of flickering, or a display manner of a prompt tone, and may also include other display manners as long as a prompt of new media source being available can be provided for a user, which will not be limited in the embodiments of the present disclosure.

For example, as shown in FIG. 4C, the enlarged identification information of the new media source is shown in the media source display region 2412; the gradually reduced identification information of the new media source is shown in the media source display region 2413; and the identification information of the new media source reduced to a standard size in the media source display region 2400 is shown in the media source display region 2414.

For example, as shown in FIG. 4C, when a new host among the subscribed hosts starts a live streaming, the avatar of the new host who starts a live streaming may be enlarged and then reduced to overlay the avatar of the previous host, and then the number may be increased by 1 by flipping, indicating that there is a new host starting a live streaming.

In the embodiments of the present disclosure, in such a display manner, a real-time prompt of a new media source starting a live streaming may be provided for a user, thereby enhancing the use experience of the user. In addition, the display region for the media content is enlarged to show more media content information, thereby enhancing the user experience and increasing the volume of information of user activities. Meanwhile, the display of the media sources is changed by sliding up and down, allowing for dynamic carousel. The interactive ways are enriched and the diversified interaction demands are met better.

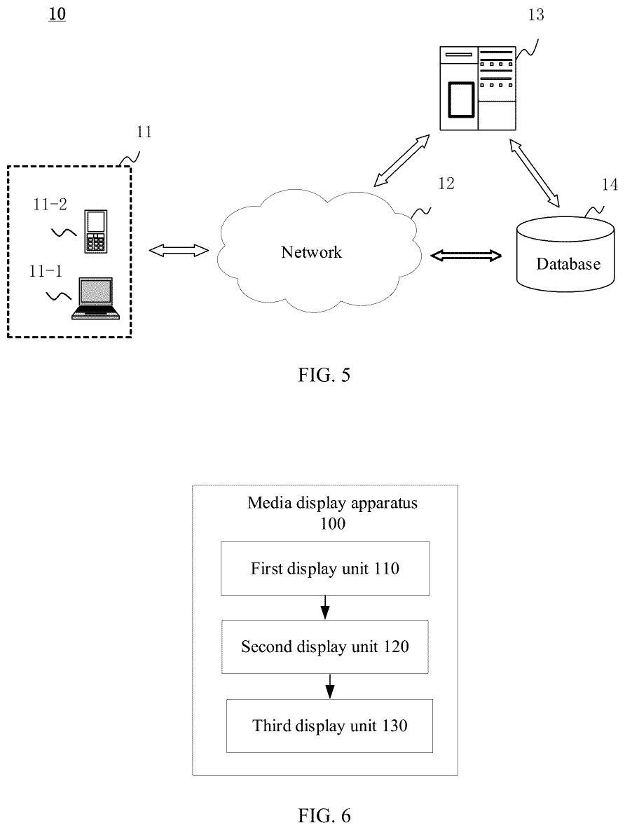

FIG. 5 is a schematic diagram of a media display system provided in at least one embodiment of the present disclosure.

For example, the media display method provided in the above embodiments may be implemented by the media display system shown in FIG. 5. As shown in FIG. 5, the media display system 10 may include a terminal device 11, a network 12, a server 13, and a database 14.

The terminal device 11 may be, for example, a computer 11-1 or a mobile phone 11-2 shown in FIG. 5. It will be understood that the terminal device 11 may be any other type of electronic devices capable of performing data processing, which may include but be not limited to a desktop computer, a laptop, a Pad, a smart phone, an intelligent home device, a wearable device, a vehicle-mounted electronic device, a monitoring device, etc. The terminal device may also be any equipment provided with an electronic device, such as a vehicle and a robot.

A user may operate an application installed on the terminal device 11. The application transmits user behavior data to the server 13 via the network 12. The terminal device 11 may also receive the data transmitted by the server 13 via the network 12. The terminal device 11 may implement the media display method provided in the embodiments of the present disclosure by running subprograms or sub-threads.

For example, when the user opens a media display interface on the terminal device 11, the server 13 transmits the media content shown in the media display region 2200 and the identification information of the currently available media sources shown in the media source display region 2100 to the terminal device 11 via the network 12. For example, the terminal device 11 may include a touch screen. Therefore, the user may directly tap on the screen at a position using a finger to implement an interactive operation with the media display interface. For example, the terminal device 11 may also include a mouse. Therefore, the user may click on the position of a cursor on the screen by using the mouse to implement the interactive operation with the media display interface.

In some embodiments, a processing unit of the terminal device 11 may be utilized to perform the media display method provided in the embodiments of the present disclosure. In some implementation, the terminal device 11 may utilize a built-in application of the terminal device 11 to perform the media display method. In some other implementations, the terminal device 11 may utilize an application stored externally to the terminal device 11 to perform the media display method provided in at least one embodiment of the present disclosure.

In some other embodiments, the terminal device 11 transmits a first operation instruction received to the server 13 via the network 12, and the position and the size of the media source display region are adjusted and the identification information of the second number of media sources needing to be shown in the adjusted media source display region is obtained by the server 13, and the position, the size, and the identification information are transmitted to the terminal device for display. In some implementations, the server 13 may utilize a built-in application of the server to perform the media display method. In some other implementation, the server 13 may invoke an application stored externally to the server 13 to perform the media display method.

The network 12 may be a single network, or a combination of at least two different networks. For example, the network 12 may include but be not limited to a combination of one or more of a local area network, a wide area network, a public network, and a private network.

The network is, for example, Internet, an Intranet, and a wireless network, a wireless local area network (LAN) and/or a metropolitan area network (MAN) such as a cellular telephone network. Wireless communication may be any of a plurality of communication standards, protocols, and techniques, including but not limited to Global System for Mobile Communications (GSM), Enhanced Data Rate for GSM Evolution (EDGE), Wideband Code Division Multiple Access (WCDMA), Code Division Multiple Access (CDMA), Time Division Multiple Address (TDMA), Bluetooth, Wi-Fi (e.g., based on IEEE 802.11a, IEEE 802.11b, IEEE 802.11g, and/or IEEE 802.11n), Voice Over Internet Protocol (VOIP), Wi-MAX, protocols for E-mail, instant messaging, and/or short message service (SMS), or any other suitable communication protocol.

In some implementations, the terminal device 11 and the server 13 may communicate by means of any network protocol currently known or to be developed in future such as HyperText Transfer Protocol (HTTP), and may achieve communication and interconnection with digital data (e.g., a communication network) in any form or of any medium. Examples of the communication network include a local area network (LAN), a wide area network (WAN), an internet work (e.g., the Internet), a peer-to-peer network (e.g., ad hoc peer-to-peer network), and any network currently known or to be developed in future.

The server 13 may be an individual server or a server group. The servers in the server group are connected by a wired or wireless network. One server group may be centralized, e.g., a data center, and may also be distributed. The server 13 may be local or remote.

The database 14 may refer to a device with a storage function in general. The database 14 is mainly configured to store various data utilized, generated, and output by the terminal device 11 and the server 13 during working. For example, the respective identification information, media contents, and the like of the media sources are stored in the database 14. The server 13 reads the identification information and the media contents to be displayed from the database 14 and transmits them to the terminal device 11 via the network 12. The terminal device 11 displays a corresponding display effect. Thus, it is realized that the currently available media sources are shown in the media source display region so that the user can perceive the currently available media sources, thereby enhancing the user experience.

The database 14 may be local or remote. The database 14 may include various memories, such as a random access memory (RAM) and a read only memory (ROM). The storage devices mentioned above are some examples, and storage devices that can be used by the system are not limited thereto.

The database 14 may be interconnected or communicate with the server 13 or a part thereof via the network 12, or may be interconnected or communicate with the server 13 directly, or in a combination of the two manners.

In some embodiments, the database 14 may be an independent device. In some other embodiments, the database 14 may also be integrated into at least one of the terminal device 11 and the server 13. For example, the database 14 may be set on the terminal device 11, and may also be set on the server 13. For another example, the database 14 may also be distributed, and has one part set on the terminal device 11 and the other part set on the server 13.

It needs to be noted that in the embodiments of the present disclosure, the flow of the media display method provided in the foregoing embodiments of the present disclosure may include more or less operations, and these operations may be performed in sequence or performed concurrently. While the flow of the media display method described above includes a plurality of operations occurring in a particular order, it will be clearly understood that the order of the plurality of operations is not limited. The media display method described above may be performed once or may be performed a plurality of times according to a predetermined condition.

FIG. 6 is a schematic block diagram of a media display apparatus provided in at least one embodiment of the present disclosure. For example, in the example shown in FIG. 6, the media display apparatus 100 includes a first display unit 110, a second display unit 120, and a third display unit 130. For example, these units may be implemented by hardware (e.g., circuit) modules or software modules, which are the same in the following embodiments and which will not be redundantly described. For example, these units may be implemented by a CPU, a GPU, a tensor processing unit (TPU), or a field programmable gate array (FPGA), or a processing unit in other form having data processing capability and/or instruction execution capability, as well as corresponding computer instructions.

The first display unit 110 is configured to provide a media display page. For example, the media display page includes a media display region and a media source display region. For example, the first display unit 110 may implement step S110, and the specific implementation method may be known with reference to the related description of step S110, which will not be described here redundantly.

The second display unit 120 is configured to obtain respective identification information of currently available media sources and show the identification information of the currently available media sources in the media source display region. For example, the second display unit 120 may implement step S120, and the specific implementation method may be known with reference to the related description of step S120, which will not be described here redundantly.

The third display unit 130 is configured to, in response to a first operation instruction for the media display page, change a display manner of the media source display region. For example, the third display unit 130 may implement step S130, and the specific implementation method may be known with reference to the related description of step S130, which will not be described here redundantly.

The media display apparatus further includes a fourth display unit configured to show a media content obtained from a media source in the media display region.

It needs to be noted that, in the embodiments of the present disclosure, the media display apparatus 100 may include more or less circuits or units, and connection relationships between the circuits or units are not limited, which may be set according to actual needs. Each circuit, which may be specifically formed in a non-limiting manner, may be composed of analog devices according to a circuit principle, and may also be composed of digital chips, or formed in other proper manners.

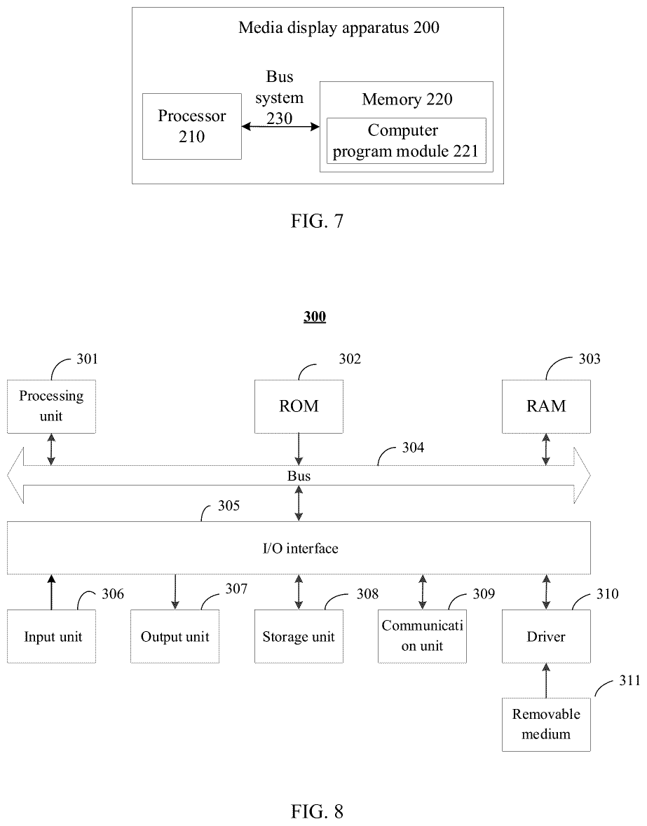

FIG. 7 is a schematic block diagram of another media display apparatus provided in at least one embodiment of the present disclosure. For example, as shown in FIG. 7, the media display apparatus 200 includes a processor 210, a memory 220, and one or more computer program modules 221.

For example, the processor 210 and the memory 220 are connected by means of a bus system 230. For example, the one or more computer program modules 221 is/are stored on the memory 220. For example, the one or more computer program modules 221 include(s) instructions for implementing the media display method provided in any embodiment of the present disclosure. For example, the instructions in the one or more computer program modules 221 may be executed by the processor 210. For example, the bus system 230 may be a common serial or parallel communication bus, which will not be limited in the embodiments of the present disclosure.

For example, the processor 210 may be a central processing unit (CPU), a digital signal processor (DSP), a graphics processing unit (GPU), or a processing unit in other form having data processing capability and/or instruction execution capability, may be a general-purpose processor or a special-purpose processor, and may control other components in the media display apparatus 200 to execute desired functions.

The memory 220 may include one or more computer program products. The computer program products may include various forms of computer-readable storage mediums, e.g., a volatile memory and/or a nonvolatile memory. The volatile memory may include, for example, a random access memory (RAM) and/or a cache, etc. The nonvolatile memory may include, for example, a read only memory (ROM), a hard disk, a flash memory, etc. One or more computer program instructions may be stored on the computer-readable storage medium, and the processor 210 may run the program instructions to realize the functions (realized by the processor 210) in the embodiments of the present disclosure and/or other desired functions, e.g., the media display method. Various applications and various kinds of data, such as media contents and the identification information of the currently available media sources as well various kinds of data used and/or generated by applications, may also be stored on the computer-readable storage medium.

It needs to be noted that, for the sake of clarity and simplicity, the embodiments of the present disclosure do not present all component units of the media display apparatus 200. To realize necessary functions of the media display apparatus 200, a person skilled in the art can provide and set other component units not shown according to specific requirements, which will not be limited in the embodiments of the present disclosure.

For the technical effects of the media display apparatus 100 and the media display apparatus 200 in different embodiments, see the technical effects of the media display method provided in the embodiments of the present disclosure, which will not be described here redundantly.

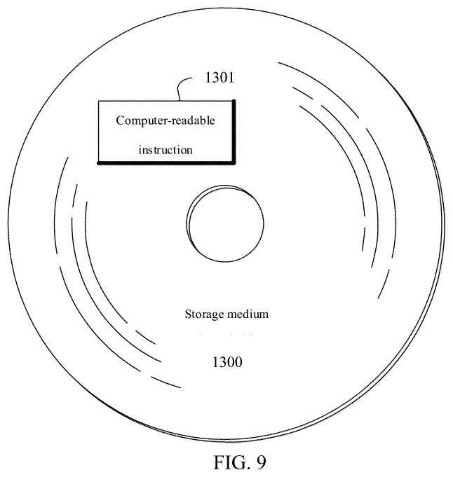

The media display apparatus 100 and the media display apparatus 200 may be applied to various suitable electronic devices. FIG. 8 is a structural schematic diagram of an electronic device provided in at least one embodiment of the present disclosure. The terminal device in the embodiment of the present disclosure may include but not be limited to mobile terminals such as a mobile phone, a notebook computer, a digital live streaming receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The electronic device shown in FIG. 8 is merely an example, and should not pose any limitation to the functions and the range of use of the embodiments of the present disclosure.

For example, as shown in FIG. 8, in some examples, the electronic device 300 includes a processing unit (e.g., a central processing unit, a graphics processing unit) 301, which can perform various suitable actions and processing according to a program stored in a read-only memory (ROM) 302 or a program loaded from a storage unit 308 into a random access memory (RAM) 303. The RAM 303 stores various programs and data required for operations of the computer system. The processing unit 301, the ROM 302, and the RAM 303 are connected to one another by means of a bus 304. An input/output (I/O) interface 305 is also connected to the bus 304.

For example, the following components may be connected to the I/O interface 305: an input unit 306 including, for example, a touch screen, a touch pad, a keyboard, a mouse, a camera, a microphone, an accelerometer, and a gyroscope; an output unit 307 including, for example, a liquid crystal display (LCD), a loudspeaker, and a vibrator; a storage unit 308 including, for example, a magnetic tape and a hard disk; and a communication unit 309 including a network interface card such as a local area network (LAN) card and a modem. The communication unit 309 may allow the electronic device 300 to be in wireless or wired communication with other devices to exchange data, and the communication processing is performed via a network such as Internet. A driver 310 is also connected to the I/O interface 305 as required. A removable medium 311, such as a magnetic disk, an optical disc, a magneto-optical disc, a semiconductor memory, or the like, is installed on the driver 310 as required, so that a computer program read therefrom can be installed in the storage unit 309 as required. While FIG. 6 illustrates the electronic device 300 having various units, it is to be understood that all the illustrated units are not necessarily implemented or included. More or less units may be implemented or included alternatively.

For example, the electronic device 300 may further include a peripheral interface (not shown in the figure) and the like. The peripheral interface may be an interface of any type, such as a USB interface and a lighting interface. The communication unit 309 may communicate with a network and other devices wirelessly. The network is, for example, Internet, an Intranet, and a wireless network, a wireless local area network (LAN) and/or a metropolitan area network (MAN) such as a cellular telephone network. Wireless communication may be any of a plurality of communication standards, protocols, and techniques, including but not limited to Global System for Mobile Communications (GSM), Enhanced Data Rate for GSM Evolution (EDGE), Wideband Code Division Multiple Access (WCDMA), Code Division Multiple Access (CDMA), Time Division Multiple Address (TDMA), Bluetooth, Wi-Fi (e.g., based on IEEE 802.11a, IEEE 802.11b, IEEE 802.11g, and/or IEEE 802.11n), Voice Over Internet Protocol (VOIP), Wi-MAX, protocols for E-mail, instant messaging, and/or short message service (SMS), or any other suitable communication protocol.

For example, the electronic device may be any device such as a mobile phone, a Pad, a laptop, an E-book, a game machine, a television, a digital photo frame, and a navigator, and may also be any combination of an electronic device and hardware, which will not be limited in the embodiments of the present disclosure.

For example, according to the embodiments of the present disclosure, the process described above with reference to the flowchart may be implemented as a computer software program. For example, an embodiment of the present disclosure includes a computer program product, which includes a computer program carried by a non-transitory computer-readable medium. The computer program includes a program code for performing the method shown in the flowchart. In such an embodiment, the computer program may be downloaded online through the communication unit 309 and installed, or installed from the storage unit 308, or installed from the ROM 302. When the computer program is executed by the processing unit 301, the media display functions defined in the method of the embodiments of the present disclosure are executed.

It needs to be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include but not be limited to: an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In embodiments of the present disclosure, the computer-readable storage medium may be any tangible medium containing or storing a program that can be used by or in combination with an instruction execution system, apparatus or device. In embodiments of the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

In some implementations, a client and a server may communicate by means of any network protocol currently known or to be developed in future such as HyperText Transfer Protocol (HTTP), and may achieve communication and interconnection with digital data (e.g., a communication network) in any form or of any medium. Examples of the communication network include a local area network (LAN), a wide area network (WAN), an internet work (e.g., the Internet), a peer-to-peer network (e.g., ad hoc peer-to-peer network), and any network currently known or to be developed in future.

The above-mentioned computer-readable medium may be included in the electronic device described above, or may exist alone without being assembled with the electronic device.

The computer-readable medium carries one or more programs. The one or more programs, when executed by the electronic device, cause(s) the electronic device to: obtain at least at least two Internet protocol addresses; transmit a node evaluation request including the at least two Internet protocol addresses to a node evaluation device which selects and returns an Internet protocol address from the at least two Internet protocol addresses; receive the Internet protocol address returned by the node evaluation device; and distribute a content indicated by the obtained Internet protocol address to edge nodes in a network.

Alternatively, the computer-readable medium carries one or more programs. The one or more programs, when executed by the electronic device, cause(s) the electronic device to: receive a node evaluation request including at least two Internet protocol addresses; select an Internet protocol address from the at least two Internet protocol addresses; return the selected Internet protocol address; and distribute a content indicated by the received Internet protocol address to edge nodes in a network.

A computer program code for performing the operations in the present disclosure may be written in one or more programming languages or a combination thereof. The programming languages include but are not limited to object oriented programming languages, such as Java, Smalltalk, and C++, and conventional procedural programming languages, such as C or similar programming languages. The program code can be executed fully on a user's computer, executed partially on a user's computer, executed as an independent software package, executed partially on a user's computer and partially on a remote computer, or executed fully on a remote computer or a server. In a circumstance in which a remote computer is involved, the remote computer may be connected to a user computer via any type of network, including a local area network (LAN) or a wide area network (WAN), or may be connected to an external computer (for example, connected via the Internet by using an Internet service provider).

The functions described above herein may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the embodiments of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include but be not limited to an electronic, magnetic, optical, electromagnetic, infrared, or semiconductor system, apparatus or device, or any appropriate combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination thereof.

At least one embodiment of the present disclosure further provides a storage medium. FIG. 9 is a schematic diagram of a storage medium provided in at least one embodiment of the present disclosure. For example, as shown in FIG. 9, the storage medium 1300 stores, in a non-transitory manner, computer-readable instructions 1301 which, when executed by a computer (including a processor), cause performing the media display method provided in any embodiment of the present disclosure.

For example, the storage medium may be any combination of one or more computer-readable storage mediums. For example, one computer-readable storage medium includes a computer-readable program code for providing a media display page, and another computer-readable storage medium includes a computer-readable program code for obtaining respective identification information of currently available media sources and displaying the identification information of the currently available media sources in a media source display region, and another computer-readable storage medium includes a computer-readable program code for changing a display manner of the media source display region in response to a first operation instruction for the media display page. For example, when the program codes are read by a computer, the computer may execute the program codes stored on the computer storage medium to perform, for example, the media display method provided in any embodiment of the present disclosure.

For example, the storage medium may include a storage card of a smart phone, a memory component of a Pad, a hard disk of a personal computer, a random access memory (RAM), a read-only memory (ROM), an erasable programmable read-only memory (EPROM), a compact disk read-only memory (CD-ROM) a flash memory, or any combination of such storage mediums, and may also be other suitable storage medium.

The following points need to be noted:
(1) The accompanying drawings in the embodiments of the present disclosure only involve structures involved in the embodiments of the present disclosure, and other structures may be designed as usual.
(2) The embodiments of the present disclosure and the features in the embodiments can be combined with one another to derive new embodiments without conflict.

The foregoing are merely descriptions of the exemplary embodiments of the present disclosure and are not meant to limit the protection scope of the present disclosure. The protection scope of the present disclosure is defined by the appended claims.

1. A media display method, comprising:
providing a media display page, wherein the media display page comprises a media source display region;
obtaining respective identification information of currently available media sources and displaying the identification information of the currently available media sources in the media source display region; and
in response to a first operation instruction for the media display page, changing a display manner of the media source display region.

2. The media display method according to claim 1, wherein the changing the display manner of the media source display region comprises:
changing a display manner of the identification information of the currently available media sources.

3. The media display method according to claim 1, wherein the display manner comprises at least one of a display position, a display size, and a display form.

4. The media display method according to claim 1, wherein
the displaying the identification information of the currently available media sources in the media source display region comprises:
displaying identification information of a first number of currently available media sources of the currently available media sources in parallel in the media source display region; and
the changing the display manner of the identification information of the currently available media sources comprises:
displaying identification information of a second number of currently available media sources of the currently available media sources, wherein the second number is less than the first number.

5. The media display method according to claim 4, wherein the displaying the identification information of the second number of currently available media sources of the currently available media sources comprises:
alternately displaying the identification information of the currently available media sources with the second number of pieces of identification information as a set.

6. The media display method according to claim 4, further comprising:
in response to the first operation instruction for the media display page, displaying a total number of the currently available media sources in the media source display region of which the display manner has been changed.

7. The media display method according to claim 6, further comprising:
updating and displaying the total number of the currently available media sources according to an increase or a decrease of the currently available media sources.

8. The media display method according to claim 6, further comprising:
in response to a new media source becoming available and thereby becoming one of the currently available media sources, displaying identification information of the new media source in the media source display region of which the display manner has been changed.

9. The media display method according to claim 6, wherein the displaying identification information of the new media source in the media source display region of which the display manner has been changed comprises:
displaying the identification information of the new media source in a different display manner from the identification information of the first number of media sources in the media source display region of which the display manner has been changed.

10. The media display method according to claim 1, wherein a media content is shown in the media display page, and the media content comprises pictures of a plurality of objects corresponding to the media content;
and the method further comprises:
displaying the pictures of the plurality of objects involved in the currently available media sources during live streaming in such a manner that the pictures are stacked; and
in response to a second operation instruction for the media display page, changing a picture of an object shown on the top of the stacked pictures.

11. The media display method according to claim 1, further comprising:
obtaining respective state information of subscribed one or more media sources, and determining the currently available media sources.

12. (canceled)

13. A media display apparatus, comprising:
a processor;
a memory; and
one or more computer program modules, wherein the one or more computer program modules are stored on the memory and configured to be executed by the processor; and
the one or more computer program modules comprise(s) instructions for execution to implement a media display method, which comprises:
providing a media display page, wherein the media display page comprises a media source display region;
obtaining respective identification information of currently available media sources and displaying the identification information of the currently available media sources in the media source display region; and
in response to a first operation instruction for the media display page, changing a display manner of the media source display region

14. A storage medium, storing, in a non-transitory manner, computer-readable instructions which, when executed by a computer, cause performing a media display method, which comprises:
providing a media display page, wherein the media display page comprises a media source display region;
obtaining respective identification information of currently available media sources and displaying the identification information of the currently available media sources in the media source display region; and
in response to a first operation instruction for the media display page, changing a display manner of the media source display region.

15. The media display method according to claim 2, wherein the display manner comprises at least one of a display position, a display size, and a display form.

16. The media display method according to claim 2, wherein
the displaying the identification information of the currently available media sources in the media source display region comprises:
displaying identification information of a first number of currently available media sources of the currently available media sources in parallel in the media source display region; and
the changing the display manner of the identification information of the currently available media sources comprises:
displaying identification information of a second number of currently available media sources of the currently available media sources, wherein the second number is less than the first number.

17. The media display method according to claim 3, wherein
the displaying the identification information of the currently available media sources in the media source display region comprises:
displaying identification information of a first number of currently available media sources of the currently available media sources in parallel in the media source display region; and
the changing the display manner of the identification information of the currently available media sources comprises:
displaying identification information of a second number of currently available media sources of the currently available media sources, wherein the second number is less than the first number.

18. The media display method according to claim 5, further comprising:
in response to the first operation instruction for the media display page, displaying a total number of the currently available media sources in the media source display region of which the display manner has been changed.

19. The media display method according to claim 7, further comprising:
in response to a new media source becoming available and thereby becoming one of the currently available media sources, displaying identification information of the new media source in the media source display region of which the display manner has been changed.

20. The media display method according to claim 7, wherein the displaying identification information of the new media source in the media source display region of which the display manner has been changed comprises:
displaying the identification information of the new media source in a different display manner from the identification information of the first number of media sources in the media source display region of which the display manner has been changed.

21. The media display method according to claim 8, wherein the displaying identification information of the new media source in the media source display region of which the display manner has been changed comprises:
displaying the identification information of the new media source in a different display manner from the identification information of the first number of media sources in the media source display region of which the display manner has been changed.
